(19) United States
(12) Patent Application Publication
(10) Pub. No.: US 2009/0313929 A1
(43) Pub. Date: Dec. 24, 2009

(54) EXTRUSION-MOLDED PRODUCT HAVING A CORE MATERIAL

(76) Inventors: Naohisa Miyakawa, Shiroi-shi (JP); Katsuhisa Kato, Inzai-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/474,602

(22) Filed: May 29, 2009

(30) Foreign Application Priority Data
Jun. 20, 2008 (JP) 2008-186520

(51) Int. Cl. B60R 13/02

(52) U.S. Cl. 52/309.1

(57) ABSTRACT

An extrusion-molded product for attaching to a flange of a vehicle body opening, such as an automotive door, trunk and backdoor comprises a core material having a U-shaped cross section along the lengthwise direction of of said core material, a coating layer of thermoplastic elastomer or rubber formed in the outside of the core material and provided with a hollow seal portion, and a pressing member of thermoplastic elastomer or rubber having a hollow portion formed integrally in the inside of the U-shaped cross section of the core material.

### BACKGROUND OF THE INVENTION

1. Field of the Invention

The present invention relates to an extrusion-molded product having a core material in the inside, such as a trim, weather strip, etc. which are attached to a flange of a vehicle body opening, such as an automotive door, trunk and backdoor.

2. Description of the prior art

The conventional extrusion-molded product having a core material, such as a trim and weather strip for attaching to a flange of the vehicle body opening, such as automotive door, weather strip and backdoor of automobile is comprised of a coating layer having a hollow seal portion and formed integrally in the outside of said core material having a U-shaped cross section along the lengthwise direction and a pressing member of thermoplastic elastomer or rubber integrally formed as a filler of solid cross section in the inside of a connecting portion of the U-shaped cross section of said core material, whereby said extrusion-molded product is attached to the vehicle body opening by pressing elastically said pressing member to an edge of the flange in order to prevent an inflow of water, reduce a noise and increase an air and water tightness in the running of automobile. However, the pressing member has a large restoration force, because of the filler of the solid cross-section, when said pressing member is contacted with the edge of the flange in all surface, and a gap is produced between the pressing member and the flange, so that the vehicle body opening can be not completely sealed. Further, there is such a problem that the restoration force is more increased in a flange, of which the vehicle body panel is partially thick.

### SUMMARY OF THE INVENTION

It is a main object of the present invention to provide an extrusion-molded product comprising a core material and coating layer, in which a pressing member having a hollow portion is formed for preventing an inflow of water, reducing a noise and increasing an air and water tightness in the running of automobile.

According to the present invention, an extrusion-molded product having a core material for attaching to the vehicle body opening comprises a coating layer of thermoplastic elastomer or rubber having a hollow seal portion formed in the outside of the core material having a U-shaped cross section along the lengthwise direction and a pressing member of thermoplastic elastomer or rubber having a hollow portion formed integrally in the inside of a connecting portion of said core material. The pressing member is formed in the inside of the connecting portion and opposed side portions of the U-shaped cross section of the core material and is provided with the hollow portion. The pressing member is provided with a channel portion. Further, the pressing member is formed integrally in a part or whole of the inside of the core material by extending said pressing member along the lengthwise direction of the core material. Said pressing member is made of thermoplastic elastomer or rubber having one or all of the physical properties of material of a type A durometer hardness (JIS K6253, value after 15 seconds) not higher than 20, a tensile stress (JIS K6251) not higher than 0.5 Mpa at the elongation time of 100%, and a rebound resilience (JIS K6255) not higher than 70%.

### BRIEF DESCRIPTION OF THE DRAWINGS

FIG. 1 is a sectional view of a first embodiment of an extrusion-molded product according to the present invention;

FIG. 2 is a sectional view showing a state in which an extrusion-molded product of the first embodiment is attached to a flange;

FIG. 3 is a sectional view of a second embodiment of an extrusion-molded product according to the present invention;

FIG. 4 is a sectional view of a third embodiment of an extrusion-molded product according to the present invention;

FIG. 5 is a sectional view of a fourth embodiment of an extrusion-molded product according to the present invention;

FIG. 6 is a sectional view of a fifth embodiment of an extrusion-molded product according to the present invention;

FIG. 7 is a side view showing a manufacturing process of an extrusion-molded product according to the present invention;

FIG. 8 is a perspective view of a core material of an extrusion-molded product according to the present invention;

FIG. 9 is a sectional view of the conventional extrusion molded product having a core material; and

FIG. 10 is a sectional view showing a state in which the conventional extrusion-molded product of FIG. 9 is attached to a flange and a gap is produced in an edge of the flange.

### DETAILED DESCRIPTION OF THE PREFERRED EMBODIMENT

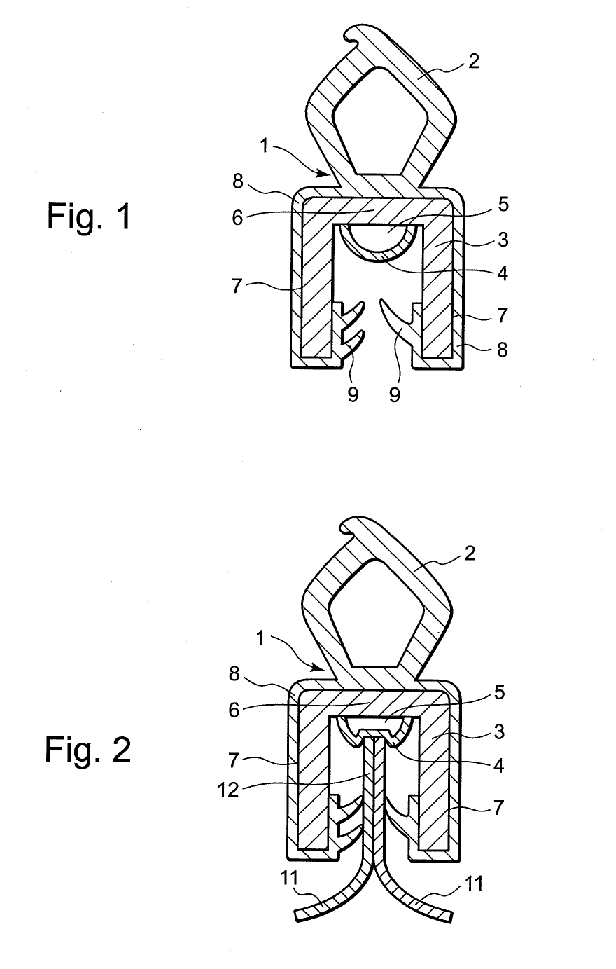

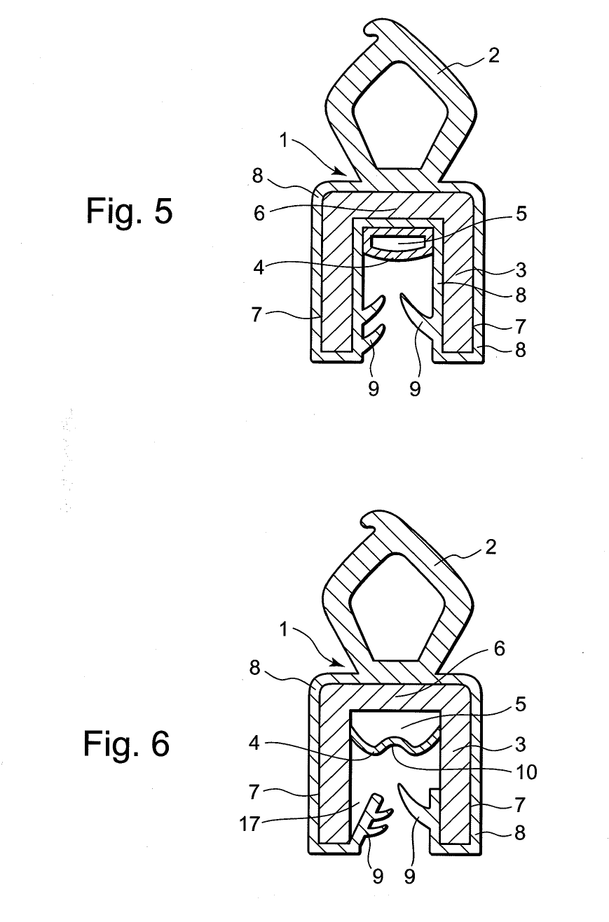

Embodiments of an extrusion-molded product according to the present invention will be described with reference to the accompanying drawings. FIG. 1 shows a first embodiment of an extrusion-molded product 1 having a core material 3 for attaching to a flange of the peripheral edge of a vehicle body opening, such as an automotive door, trunk and backdoor of automobile. The extrusion-molded product 1 comprises the core material 3 made of hard synthetic resin or metal and having a U-shaped cross section and a coating layer 8 of thermoplastic elastomer or rubber formed in the outside of said core material 3 and having a hollow seal portion 2. The core material 3 includes side portions 7,7 and a connecting portion 6 of the U-shaped cross section, and a pressing member 4 made of soft thermoplastic elastomer or rubber is formed in the inside of the connecting portion 6 of said core material and is provided with a hollow portion 5 between itself and the connecting portion 6. The pressing member 4 is formed as a semi-circle, but can be made of various shape, such as rectangle, semi-ellipse, wave-form, etc. in accordance with the necessity, and the hollow seal portion 2 is formed as a rhombic shape, but may be of various shape, such as an angular form, circle, ellipse, etc. The hollow seal portion 2 is formed in the outside of the connecting portion 6 of the core material 3, but can be formed in the desired position in the outside of the connecting portion 6 or the outside of the side portion 7,7 of the core material. The coating layer 8 is formed partially in the inside periphery of said core material 3, but can be formed wholly in the outside and inside of said core material 3 as shown in FIG. 5, and is provided with opposed holding pieces 9,9 projected inside from the side portions 7,7.

In FIG. 2, the extrusion-molded product having the core material of the present invention shown in FIG. 1 is shown in such a state that the side surfaces of the flange 12 of the vehicle body panel 11 is gripped by the opposed holding pieces 9,9 and the tip edge of the flange 12 is pressed by the pressing member 4.

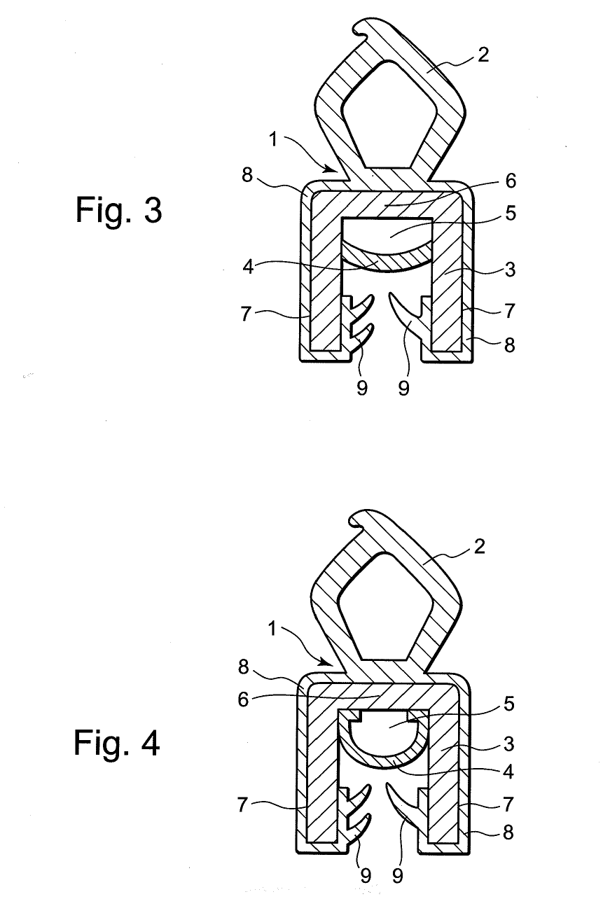

FIG. 3 shows a second embodiment of the extrusion-molded product 1 having the core material 3 of the present invention. A pressing member 4 is formed in the inside of the connecting portion 6 and the opposed side portions 7,7 of the core material 3 and is provided with a hollow portion 5 surround with the connecting portion 6, the opposed side portions 7,7 and itself.

FIG. 4 is a third embodiment of the extrusion-molded product 1 having the core material 3 of the present invention. A pressing member 4 is formed in the inside of the connecting portion 6 and the opposed side portions 7,7 of the core material 3 and is provided with opposed bottom portions connected with the connecting portion 6, and a hollow portion 5 is formed between the connecting portion 6 of the core material 3 and the pressing member 4.

FIG. 5 is a fourth embodiment of the extrusion-molded product 1 having the core material 3 of the present invention. A coating layer 8 is formed in the whole of the outside and inside of the core material 3, and a pressing member 4 is formed in the inside of the coating layer 8 and is provided with a hollow portion 5 surrounded wholly by itself.

FIG. 6 shows a fifth embodiment of the extrusion-molded product 1 having the core material 3 of the present invention. A pressing member 4 has a channel portion 10 formed in the periphery thereof, and a coating layer 8 is provided with a non heat-welded portion 17 which is not heat welded to the core material 3.

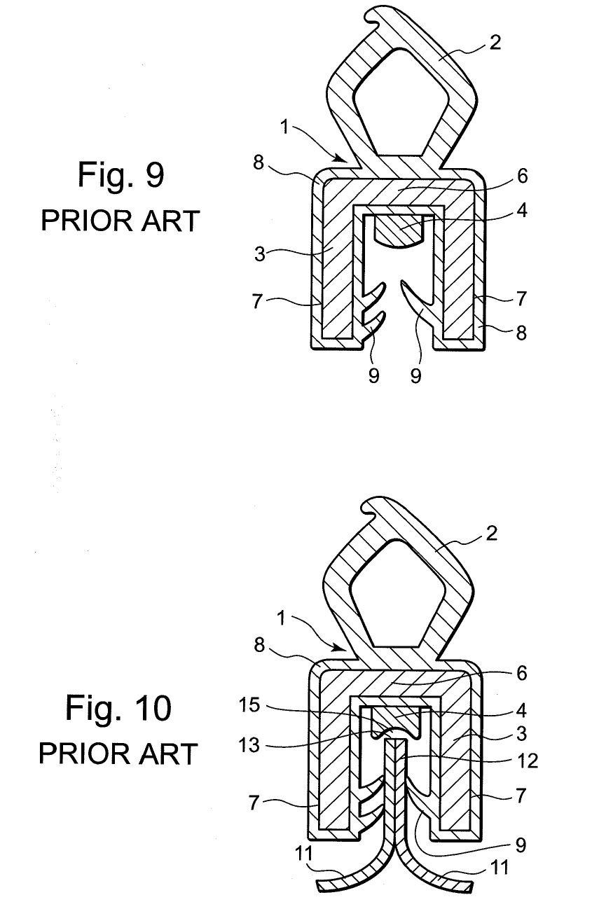

FIG. 9 shows a sectional view of the conventional extrusion-molded product 1 having a core material 3, in which a pressing member 4 of thermoplastic elastomer is formed integrally as a filler of solid cross section in the inside of a connecting portion 6 of the core material 3. FIG. 10 shows such a state that the extrusion-molded product 1 having the core material 3 of FIG. 9 is attached to a flange 12 and a gap is produced between a tip edge 13 of the flange 12 and the pressing member 4.

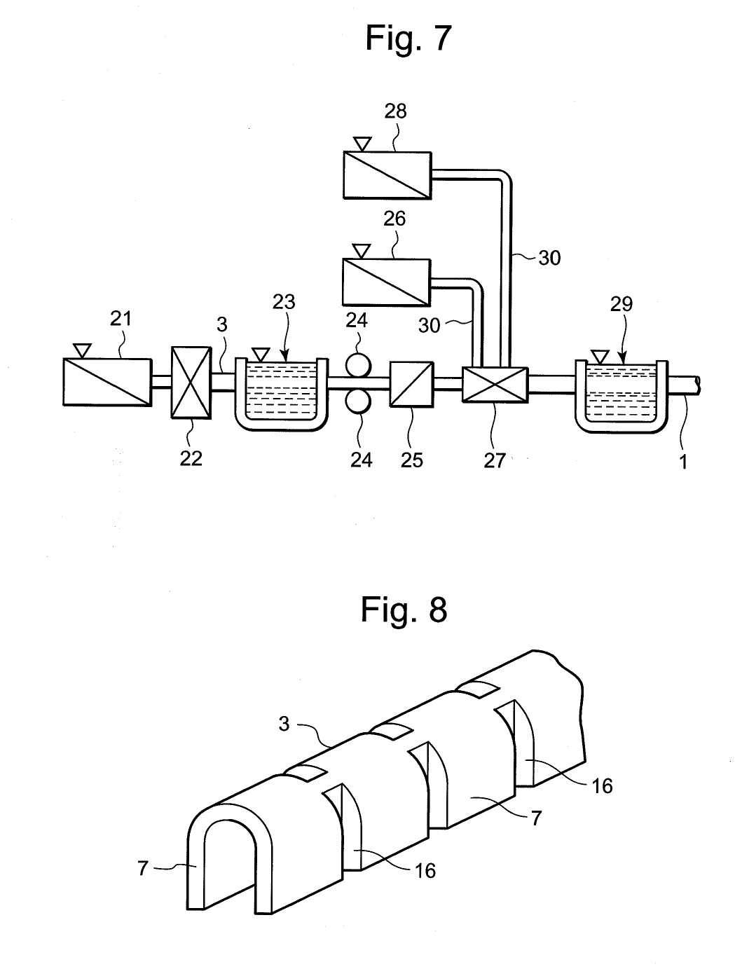

FIG. 7 shows an example of a manufacturing process of the extrusion-molded product 1 of the present invention comprising the core material 3 made of hard synthetic resin, the hollow seal portion 2, the coating layer 8 and pressing member 4 made of thermoplastic elastomer. The core material 3 having the U-shaped cross section is extrusion-molded in a first molding die 22 by using a first extruder 21, into which a hard synthetic resin is poured, and then the core material 3 having the U-shaped cross section is cooled by being caused to pass through a cooling tank 23 and is taken out by drawing rollers 24, 24 from the cooling tank 23. Next, cut portions 16,16 having various shapes as shown in FIG. 8 are formed by a punching machine 25 in the side portions 7,7 or parts of the connecting portion 6 of the core material 3. Subsequently, the core material 3 having the cut portions 16,16 is carried to a second molding die 27. In the second molding die 27, a thermoplastic elastomer in the melting state which is poured in to a second extruder 26 is extrusion-molded and is heat-welded to the outside and/or inside of the core material 3 for forming the coating layer 8 and hollow seal portion 2 and a thermoplastic elastomer in the melting state which is poured into a third extruder 28 is extrusion-molded and is heat-welded to the inside of the core material 3 for forming the pressing member 4 and then the extrusion-molded product 1 having the coating layer 8, hollow seal portion 2 and pressing member 4 heat-welded to the core material 3 is cooled by being caused to pass through a second cooling tank 29. Reference numeral 30 denotes a pouring pipe. In case that two thermoplastic elastomers having different hardness are used separately to the hollow seal portion 2 and coating layer 8, a fourth extruder is added, and the coating layer 8 is extrusion-molded in the second molding die 27 by using the second extruder 26 and the hollow seal portion 2 is extrusion-molded in the second molding die 27 by using the fourth extruder. In this example, the coating layer 8 is heat-welded to the core material 3, but it is able to form a non heat-welding portion 17, in which a part of the coating layer 8 is not heat-welded to the core material 3 as shown in FIG. 6. Further, in such a manufacturing process that the hollow seal portion 2, coating layer 8 and pressing member 4 are produced by rubber, a vulcanizing tank is added posterior to the second molding die 27.

The materials to be used in the extrusion-molded product of the present invention will be described hereunder in details. The core material 3 having the U-shaped cross section is made of a hard synthetic resin, in which an olefin based resin with a type A durometer hardness (JIS K6253, value after 15 seconds) more than 85, or a mixed synthetic resin having powders of talk, etc. of 20 to 50 weight % mixed into an olefin based resin is used to improve the rigidity and decrease the liner expansion coefficient thereof. For example, the liner expansion coefficient is 1.4×10⁻⁴ in the synthetic resin core material made of a polypropylene of 100 weight %, whereas the liner expansion coefficient is decreased to 0.33 ×10⁻⁴ in the mixed synthetic resin having the powders of talk of 40 weight % mixed into the polypropylene of 60 weight %. In case that a metal, such as an iron, aluminum and stainless steel is used as the core material 3 having the U-shaped cross section, the liner expansion coefficient is more decreased and for example, the liner expansion coefficient is 0.1×10⁻⁴ in the iron.

Further, an olefin based thermoplastic elastomer or foam thereof, or a stylene based thermoplastic elastomer or foam thereof is used as the material of thermoplastic elastomer for forming the coating layer 8, hollow seal portion 2 and pressing member 4. As the material of rubber for forming the coating layer 8, hollow seal portion 2 and pressing member 4, an ethylene propylene rubber (EPDM) or foam thereof is used. Particularly, an olefin based thermoplastic elastomer, or rubber thereof to be used as the pressing member 4 is provided with one or all of the physical properties having a type A durometer hardness (JIS K6253, value after 15 seconds) not higher than 20, a tensile stress (JIS K6251) not higher than 0.5 Mpa at the elongation time of 100% and a rebound resilience (JIS K6255) not higher than 70 % so as to be able to easily collapse and press the hollow portion 5 of the pressing member 4 to the flange 12.

As an example in case that a different hardness of thermoplastic elastomer is used for forming the coating layer 8, hollow seal portion 2 and pressing member 4, a thermoplastic elastomer or rubber having a type A durometer hardness 40 to 80 (JIS K6253, value after 15 seconds) is used for forming the coating layer 8, a thermoplastic elastomer or rubber having a type A durometer hardness 20 to 60 (JIS K6253, value after 15 seconds) is used for forming the hollow seal portion 2, and a thermoplastic elastomer or rubber having a type A durometer hardness not higher than 20 (JIS K6253, value after 15 seconds) more soft than that of the hollow seal portion 2 is used for forming the pressing member 4 with the hollow portion 5.

As an available example of the physical property of the material to the pressing member 4, it is preferable to use a thermoplastic elastomer, or rubber, or foam thereof which has any one of a type A durometer hardness (JIS K6253, value after 15 seconds) 1 to 20, a tensile stress (JIS K6251) 0.05 to 0.5 Mpa at the elongation time of 100%, or a rebound resilience (JIS K6255) 30 to 70%.

Further, as the pressing member 4 more soft than the hollow seal portion 2, it is able to use a thermoplastic elastomer, or rubber, or foam thereof, which is provided with an adhesiveness. In the extrusion-molded product having the core material which is constituted as described above according to the present invention, as a pressing member 4 made of a thermoplastic elastomer or rubber is integrally formed in the inside of a connecting portion 6 of the core material 3 having a U-shaped cross section for forming a hollow portion 5, the restoration force is little and the pressing member 4 can be easily collapsed, because the hollow portion 6 is made, so that it is possible for the pressing member 4 to seal up the tip edge of a flange 12 and prevent an inflow of water, reduce a noise and increase an air and water tightness in the running of automobile.

In other embodiment of the extrusion-molded product having the core material according to the present invention, as a pressing member 4 for forming a hollow portion is integrally formed in the inside of a connecting portion 6 and between opposed side portions 7 and 7 of the core material 3 having a U-shaped cross section, it is possible for the pressing member 4 to seal up the tip edge of a flange 12 in the stable state, because the pressing member 4 is formed along both side portion 7,7 of the core material 3, even if the position of the flange 12 is slightly diverged to the right or left from the center of the core material 3. In the pressing member 4, in which a channel portion 10 is formed, the sealing between the flange 12 and the pressing member 4 is enhanced, because the tip edge of the flange 12 is inserted into the channel portion 10. In the pressing member 4 which is integrally formed in a whole of the inside of the core material 3 by extending continuously said pressing member 4 along the lengthwise direction of the core material 3, the contacting surface between the pressing member 4 and core material 3 is increased and the pressing member 4 can be firmly formed integrally with the core material 3. In the pressing member 4 which is integrally formed in a part of the inside of the core material 3 by extending intermittently said pressing member 4 along the lengthwise direction of the core material 3, the pressing member 4 can be economized on a thermoplastic elastomer or rubber material.

In addition, by making the pressing member 4 of a thermoplastic elastomer or rubber having one or all of the physical properties of a type A durometer hardness (JIS K6253, value after 15 seconds) not higher than 20, a tensile stress (JIS K6251) not higher than 0.5 Mpa at the elongation time of 100% and a rebound resilience (JIS K6255) not higher than 70%, the material of the pressing member 4 is more softened and the flange 12 can be easily thrust in the pressing member 4 by pressing and squeezing the pressing member 4 to the flange 12, so that it is possible to prevent an inflow of water, to reduce a noise in the running of an automobile owing to an air tightness and to enhance a sealing to the flange 12. Furthermore, the tight connection between the pressing member 4 and flange 12 is enabled by the pressing member 4 made of a thermoplastic elastomer or rubber more soft than that of the coating layer as well as the hollow seal portion 2 and the complete sealing is obtained by the pressing member 4 made of a thermoplastic elastomer or rubber having an adhesiveness, so that the tip edge of the flange 12 is prevented from generating a rust.

1. An extrusion-molded product for attaching to a flange of a vehicle body opening, such as an automotive door, trunk and backdoor comprising:
a core material having a U-shaped cross section along the lengthwise direction of said core material;
a coating layer of thermoplastic elastomer or rubber formed in the outside of the core material and provided with a hollow seal portion; and
a pressing member of thermoplastic elastomer having a hollow portion formed in the inside of a connecting portion of the U-shaped cross section of the core material.

2. The extrusion-molded product having the core material according to claim 1, wherein the pressing member is formed integrally in the inside of the connecting portion and opposed side portions of the U-shaped cross section of said core material.

3. The extrusion-molded product having the core material according to claim 1, wherein the pressing member is provided with a channel portion.

4. The extrusion-molded product having the core material according to claim 1, wherein the pressing member is formed integrally in a part or whole of the inside of the core material.

5. The extrusion-molded product having the core material according to claim 1, wherein the coating layer is formed in a part or whole of the inside of the core material.

6. The extrusion-molded product having the core material according to claim 5, wherein the coating layer is formed between the core material and pressing member.

7. The extrusion-molded product having the core material according to claim 1, wherein the pressing member is made of a thermoplastic elastomer or rubber having a hardness not higher than 20.

8. The extrusion-molded product having the core material according to claim 1, wherein the pressing member is made of a thermoplastic elastomer or rubber having a tensile stress not higher than 0.5 Mpa at the elongation time of 100%.

9. The extrusion-molded product having the core material according to claim 1, wherein the pressing member is made of a thermoplastic elastomer or rubber having a rebound resilience not higher than 70%.

10. The extrusion molded product having the core material according to claim 1, wherein the pressing member is made of a thermoplastic elastomer or rubber having an adhesiveness.

11. The extrusion molded product having the core material according to claim 1, wherein the core material is made of a hard synthetic resin.

12. The extrusion molded product having the core material according to claim 1, wherein the core material is made of a metal.
